(19) United States
(12) Patent Application Publication
(10) Pub. No.: US 2025/0264978 A1
(43) Pub. Date: Aug. 21, 2025

(54) FLIGHT DECK SYSTEM WITH IMPROVED CHART DISPLAY

(71) Applicant: Garmin International, Inc., Olathe, KS (US)

(72) Inventors: Zebulun A. Emerson, Chandler, AZ (US); Sarah Zendle, Chandler, AZ (US)

(21) Appl. No.: 19/054,018

(22) Filed: Feb. 14, 2025

Related U.S. Application Data
(60) Provisional application No. 63/554,238, filed on Feb. 16, 2024.

(51) Int. Cl. G06F 3/0484; G08G 5/21; G08G 5/30; G08G 5/54

(52) U.S. Cl. CPC G06F 3/0484; G08G 5/21; G08G 5/30; G08G 5/54; G06F 2203/04806

(57) ABSTRACT

An aviation navigation display can include a screen, a processor, and a memory storing instructions executable by the processor. A selected portion to be flown of a charted aviation procedure can be displayed on the screen with information labels while excluding an unselected portion not to be flown. The information labels have priority ratings and include leg labels and point labels. Leg labels indicate leg procedural information about a corresponding leg on the chart. Point labels indicate point procedural information about a corresponding point on the chart. The information labels can be decluttered for a zoomed out view and resulting display conflicts can be resolved between the information labels in favor of those with a relatively higher priority rating.

### RELATED APPLICATION

This application claims the benefit of U.S. Provisional Patent Application No. 63/554,238, filed on Feb. 16, 2024, titled “FLIGHT DECK SYSTEM WITH IMPROVED CHART DISPLAY,” the entire disclosure of which is incorporated herein by reference.

### TECHNICAL FIELD

The present disclosure relates generally to systems, methods, and executable instructions for decluttering an aviation navigation display.

### BACKGROUND

Pilots rely on charted aviation procedures (“charts”) when navigating aircraft. Charts are used both prior to flight and inflight. Charts are used prior to take-off to familiarize the pilot with the procedures indicated in the charts as part of a briefing prior to take-off. The pilot will often times memorize the chart layout and where to find the charted procedural information. During flight it is important for the pilot to be able to reference the chart quickly without incurring additional workload.

Current charts, also known as paper charts, are crafted by cartographers. The charts they create provide a single static depiction of the chart. The charts will often times be drawn “not to scale” to optimize the space and placement of labels to maximize readability when briefing and reviewing the chart. The depictions that they craft provide a single static view of the chart where placement of labels is done by hand and the cartographer will use artistic licenses to draft the chart “not to scale” to ensure the procedural information fits and is easy to read.

Advances in data driven chart technology are enabling improved presentation on electronic screens when compared to the paper charts once relied upon by pilots. However, existing aviation charting solutions may use not-to-scale maps to ensure that the procedural information is easily accessible to the pilot, while non-safety-critical mapping applications such as Google Maps™ may use a clocking and decluttering algorithm that removes labels without any specific organization as the user zooms in and out.

### BRIEF DESCRIPTION OF THE DRAWINGS

The detailed description references the accompanying figures. The use of the same reference numbers in different instances in the description and the figures may indicate similar or identical items. In addition, the proportion and the relative scale of the elements provided in the figures are intended to illustrate various embodiments and are not to be used in a limiting sense.

FIG. 1A is a first page of a charted aviation procedure known as the SMMUR TWO departure from Denver International Airport.

FIG. 1B a second page of the SMMUR TWO departure.

FIG. 2A illustrates a display of the SMMUR TWO departure.

FIG. 2B illustrates a display of a selected portion to be flown of the SMMUR TWO departure.

FIG. 3A illustrates a display of initial legs of a charted aviation procedure known as the JOHKR FIVE departure from Harry Reid International Airport in Las Vegas at a zoomed in view.

FIG. 3B illustrates a display of subsequent legs of the JOHKR FIVE departure at a less zoomed in view.

FIG. 3C illustrates a display of subsequent legs of the JOHKR FIVE departure at a zoomed out view.

FIG. 4A illustrates a display of a charted aviation procedure known as the OOSHN FIVE arrival to General Edward Lawrence Logan International Airport in Boston at a zoomed out view.

FIG. 4B illustrates a display of the OOSHN FIVE arrival at a less zoomed out view.

FIG. 4C illustrates a display of intermediate legs of the OOSHN FIVE arrival at an intermediate zoomed view.

FIG. 4D illustrates a display of final legs of the OOSHN FIVE arrival at a zoomed in view.

FIG. 5A illustrates a display of intermediate legs of a charted aviation procedure known as the FYTTE SEVEN arrival into Chicago O'Hare International Airport at a zoomed out view.

FIG. 5B illustrates a display of intermediate legs of the FYTTE SEVEN arrival at a zoomed in view.

FIG. 6A illustrates a display of several legs of a charted aviation procedure known as the SUDDZ ONE departure from Denver International Airport at a zoomed out view.

FIG. 6B illustrates a display of several legs of the SUDDZ ONE departure at a zoomed in view.

FIG. 7 illustrates a generic charted aviation procedure with various regions identified for geometry processing.

FIG. 8A illustrates information label placement vectors associated with the generic charted aviation procedure.

FIG. 8B illustrates inlets vectors associated with the generic charted aviation procedure.

FIG. 8C illustrates cutout vectors associated with the generic charted aviation procedure.

FIG. 9 is a block diagram of a system for decluttering an aviation navigation display.

FIG. 10 is a diagram of a stateless architecture employed by embodiments of the present invention.

### DETAILED DESCRIPTION

The present disclosure describes systems, methods, and executable instructions for decluttering an aviation navigation display and flight deck systems with improved chart displays. The chart functionality described herein allows improved label placement and procedural information decluttering to enhance the readability and usability of charted aviation procedures (“charts”). Examples of such charted aviation procedures include departures, arrivals, and approaches. Other examples of charts include airport diagrams and enroute charts, among others. Charts include many information labels that include procedural or other information pertinent to the chart. Examples of such labels include leg labels and point labels.

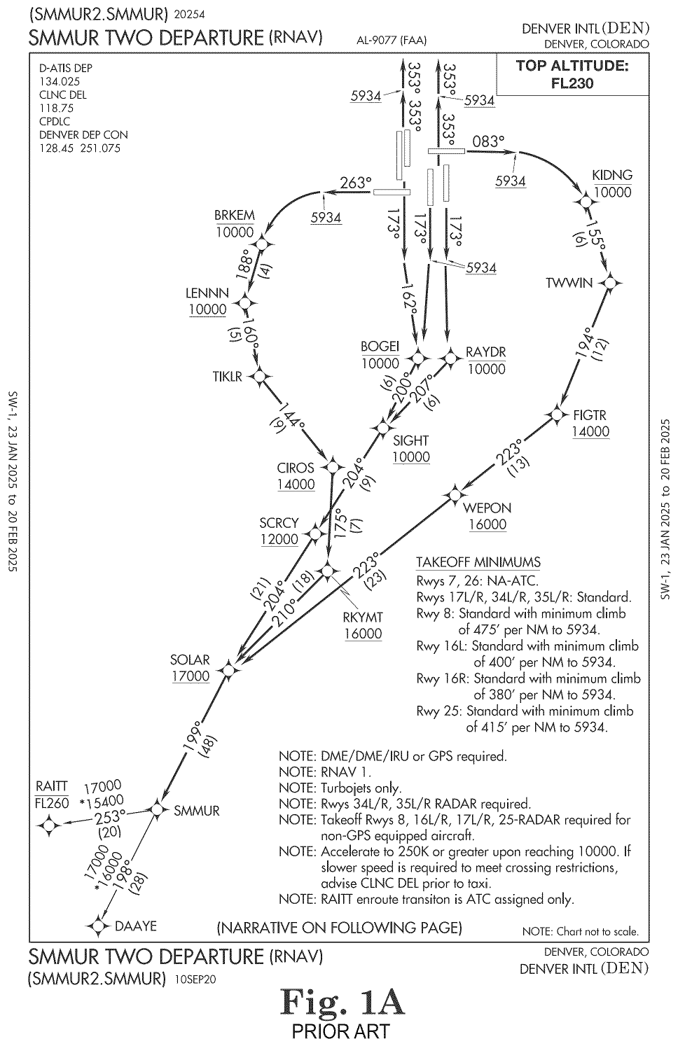

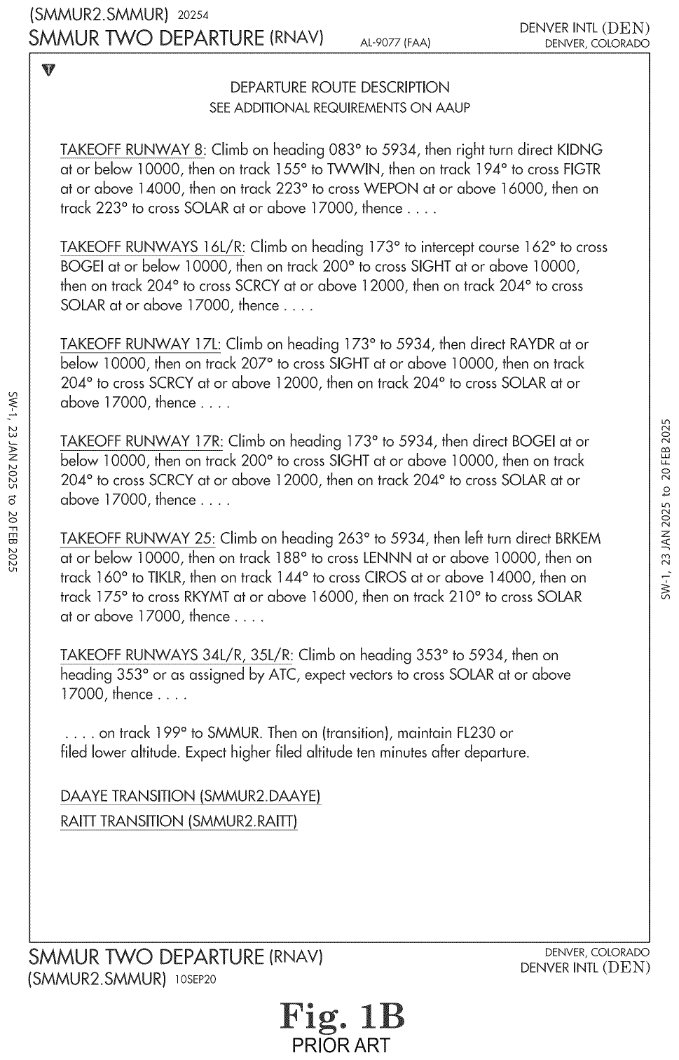

FIG. 1A is a first page of a charted aviation procedure known as the SMMUR TWO departure from Denver International Airport. FIG. 1B a second page of the SMMUR TWO departure. This is an example of a charted aviation procedure known as a departure procedure (DP). Such charts are sometimes referred to as government charts and are published by the Federal Aviation Administration (FAA). As noted above and indicated on the chart itself, the charts are not necessarily drawn to-scale.

Examples of DPs include standard instrument departures (SIDs), obstacle departure procedures (ODPs), and diverse vector areas (DVAs). DPs are the procedures used for departing an airport. DPs start at one or more runways and end at one or more enroute transitions. DPs are primarily designed for system enhancement and to reduce pilot/controller workload. Once cleared to fly the DP, the pilot can generally fly it without the controller having to instruct the pilot on the details of each leg and/or point of the procedure.

Charted aviation procedures typically include procedural information about departure or arrival runways, as well as procedural information about each leg of the procedure to be flown, such as headings, distances, and/or speed and altitude restrictions for each leg of the procedure. The legs of the procedure are typically identified by solid lines with arrows between identified points. For example, on the right side of the SMMUR TWO departure, there is a leg between the points “TWWIN” and “FIGTR” that includes heading information (“194°”) and distance information (“12”, indicating that the leg is 12 nautical miles long). TWWIN does not have an altitude restriction associated with it, but the previous point “KIDNG” includes the number “10000” with an overbar, indicating that the pilot must stay at or below 10,000 feet before reaching KIDING. The point “FIGTR” includes the number “14000” with an underbar, indicating that the pilot must be at or above 14,000 feet when crossing FIGTR. The points on charts can be waypoints, fixes, navaids, latitude/longitude coordinates, etc. The second page of the SMMUR TWO departure, illustrated at FIG. 1B, includes additional textual information to help the pilot understand what is depicted on the first page and to spell out requirements for the procedure depending on which runway is used for takeoff.

As is evident from FIGS. 1A-1B, the chart includes a wealth of procedural information that can be difficult for pilots to read and understand quickly. Typically, pilots will brief the chart in advance of flying the procedure in order to familiarize themselves with the information. However, there is a lot of information to remember. Additionally, due to the dynamic nature of the national airspace system, a pilot may be assigned a different procedure than initially planned, requiring the pilot to quickly brief a different chart on the fly. Furthermore, many large airports have many different charts. For example, as of the time of this writing, there are currently 21 different DPs for Denver International Airport. Pilots carry paper copies of the charts and/or electronic copies in an electronic flight bag, such as a tablet.

Some electronic systems generate chart displays dynamically to render a to-scale depiction of the chart. However, the to-scale representation of the chart presents a unique problem for label placement: procedural information should be displayed on the chart in a way that minimizes pilot workload in finding safety-critical information, while preserving the to-scale, dynamic nature of the chart.

At least one embodiment described herein addresses the above and other deficiencies. The Garmin® Smart Charts™ or Garmin® Charts are generated dynamically using the Flight Management System (FMS) data and other information stored in a database to render a to-scale depiction of the charted aviation procedure. This includes dynamic placement of information labels that should fulfill the criteria of the craftmanship of paper charts. In general, this means placing the labels in the empty space around the procedure, in an organized manner, where the information label is near the point it pertains to without occluding the procedure or other information labels, and the placement of the information label is fluid such that it is allowed to move as the available space changes while still placing in a consistent manner that is easy for the user to track and memorize. In order to provide a seamless user experience while briefing a chart, the information label placement algorithm uses dynamic label placement in combination with sequential zoom scale decluttering to smoothly move and remove procedural information in a manner that eases the pilot's briefing and therefore sound safety decision-making. Runtime logic includes dynamic label placement logic and display conflict resolution logic. The dynamic label placement logic displays labels in an organized manner such that the user can track labels easily and memorize the position of labels on the chart.

In general, information labels should be located in an organized manner around the procedure geometry. The user will brief/read the procedure linearly by following the geometry from a start point to a common or end point. Information labels should be placed such that they follow the order of the lines in the geometry in a consistent manner to aid in the reading and following of sequential elements.

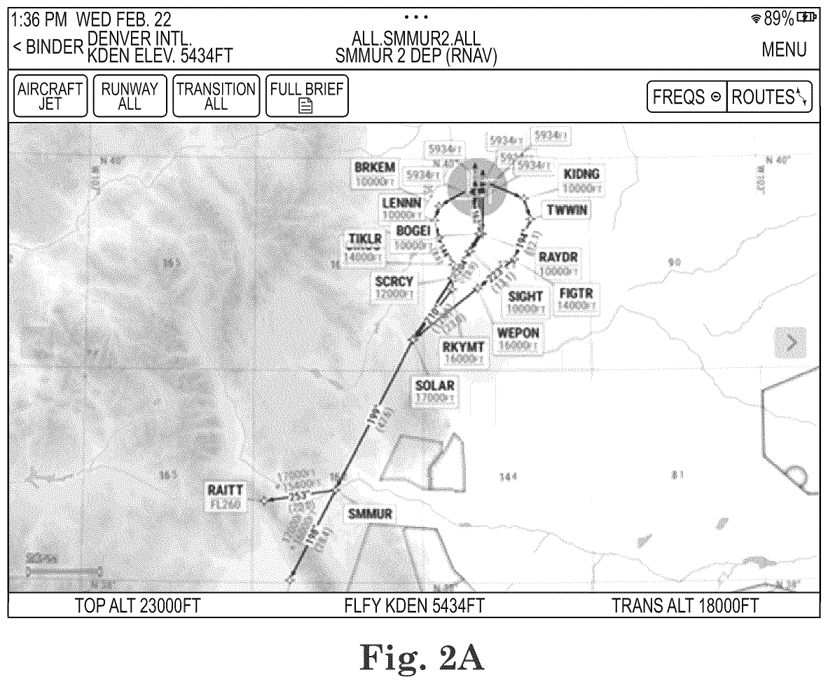

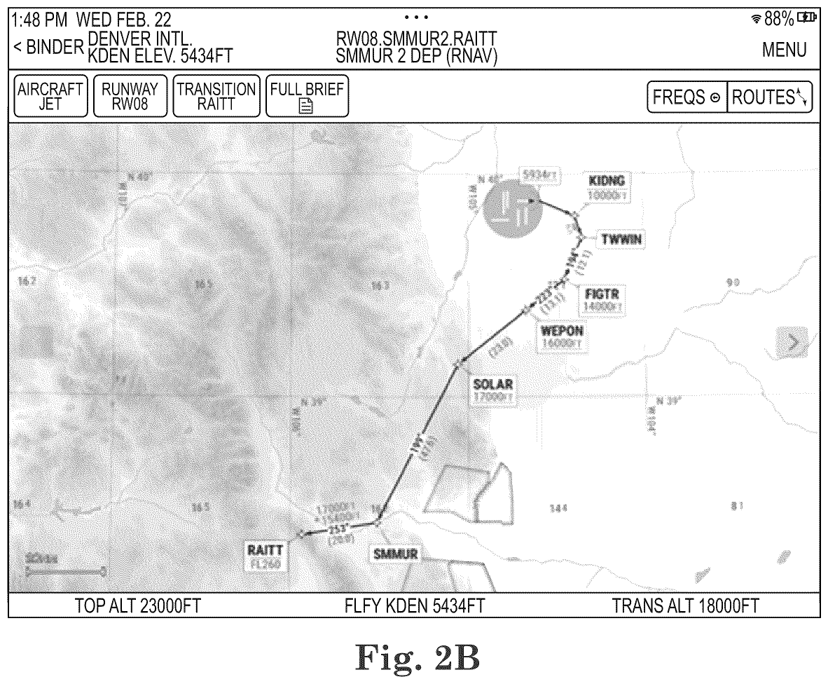

FIG. 2A illustrates a display of the SMMUR TWO departure. The SMMUR TWO departure has been rendered to-scale and formatted in a more user-friendly style than the government chart. For example, the chart is overlayed on georeferenced terrain data as indicated by the different shading regions as well as the depictions of rivers. The chart is displayed with information labels, such as point labels and leg labels. The process for placing information labels can use a number of pipe and filter stages that can be defined as placing leg and point labels around a graph topology that is represented on the surface of a two dimensional or three dimensional surface. This topology is defined by the points and the legs (edges in graph terminology) that define the flight path from one point to another.

The point labels are connected to points on the chart with lead lines and are displayed as text boxes, each indicating point procedural information about a corresponding point on the chart. For example, the point label for KIDNG includes the point name in text “KIDNG” as well as the altitude restriction displayed as “10000 ft” with an overbar. The leg labels each indicate leg procedural information about a corresponding leg on the chart. The leg labels are text strings placed in proximity to the corresponding leg. For example, the leg between SOLAR and SMMUR includes the text string “199°” placed on top of the leg line, indicating that the heading to be flown between SOLAR and SMMUR is 199 degrees. The same leg includes the text string “(47.6)”, indicating that the distance of the leg is 47.6 nautical miles. The distance text string is placed just below the text string indicating the heading.

Note in FIG. 1A, that the leg between WEPON and SOLAR is indicated as being 23 nautical miles long and the leg between SOLAR and SMMUR is indicated as being 48 nautical miles long. However, the leg between SOLAR and SMMUR is drawn to be about half as long as the previous leg. In contrast, in FIG. 2A, the leg between WEPON and SOLAR and the leg between SOLAR and SMMUR are drawn to-scale, giving the viewer an immediate intuitive understanding of the relative distances for those legs, as well as all of the other legs depicted on the chart.

Much like the depiction in FIG. 1A, the display of the SMMUR TWO departure in FIG. 2A includes all of the possible departure paths for the different runways illustrated. However, in practice on a given departure, the pilot would only fly one of those possible portions of the procedure. Once assigned a departure runway, the display of the SMMUR TWO departure can change as illustrated in FIG. 2B.

FIG. 2B illustrates a display of a selected portion to be flown of the SMMUR TWO departure. To enhance the usefulness of the chart, the pilot may select information relevant to a planned departure and the flight deck system may label chart, including legs and points, with information only associated with the selected departure (e.g., runway, transitions, etc.). For the display shown in FIG. 2B, runway 8 has been selected for departure. A selected portion of the SMMUR TWO departure to be flown (e.g., that associated with runway 8) is displayed along with corresponding information labels, while unselected portions of the SMMUR TWO departure not to be flown (e.g., those associated with runways 16L, 16R, and 25) are excluded. Furthermore, the RAITT transition to the enroute segment has been selected as the portion to be flown and is therefore displayed as the final point on the chart (see the bottom left of FIG. 2B). Meanwhile, the DAAYE transition has been excluded from the display as a portion of the procedure not to be flown.

The presentation of the SMMUR TWO departure illustrated in FIG. 2B is much easier for the pilot to see, quickly interpret, and understand without all of the clutter associated with the other portions of the DP, which will not be flown. This decreases pilot workload while increasing safety and efficiency. In some embodiments, an indication of the selected portion to be flown can be received from the pilot (e.g., via operation of a user interface). In some embodiments, an indication of the selected portion to be flown can be received from an electronic (e.g., an FMS or a mobile device) device having a flight plan programmed therein.

Although not specifically illustrated, a similar decluttering process can be applied to displays of arrival procedures. Arrival procedures are procedures for arriving at an airport. These procedures start at one or more enroute transitions and end at one or more runway transitions, prior to the final approach. Standard terminal arrival (STAR) charts are designed to expedite air traffic control arrival procedures and to facilitate transition between enroute and instrument approach operations. Like DPs, each STAR is represented by a separate chart and large airports often have a multitude of STARs available. Furthermore, DPs and STARS often serve multiple airports in a given geographical location. Arrivals can be decluttered based on a selected and/or assigned transition from the enroute environment, a selected and/or assigned arrival airport, and a selected and/or assigned runway at the arrival airport.

Although not specifically illustrated, a similar decluttering process can be applied to displays of instrument approach procedures (IAPs). IAPs portray the aeronautical data required to execute an instrument approach to an airport. IAPs start at one or more runway transitions and end at a runway. They also contain one or more missed approach procedures that are flown when the landing is missed. IAPs depict the procedures, including related data, and the airport diagram. Each IAP is designed for use with a specific type of electronic navigation system including non-directional beacon (NDB), tactical air navigation (TACAN), very high frequency omnidirectional range (VOR), instrument landing system (ILS), area navigation (RNAV), and ground based augmentation system landing system (GLS). A given runway at a given airport may have multiple different IAPs available for use. IAPs can be decluttered based on a selected and/or assigned initial approach fix or other entry to the procedure from the arrival, such as radar vectors.

IAPs can be decluttered for a selected and/or assigned one of the available missed approach procedures. Unselected and/or unassigned missed approach procedures can be excluded from the display. In some embodiments, the selected and/or assigned missed approach procedure can be included in the display of the IAP. The selected and/or assigned missed approach procedure can be displayed as additional points, legs, and/or holding patterns beyond the landing runway. In some embodiments, the selected and/or assigned missed approach procedure can be excluded from the display of the IAP until it is apparent that the landing will not be completed (e.g., based on avionics data indicating that the aircraft is not landing, based on the pilot pressing a “go-around” or “unsuspend” button, or based on other indicia), at which point the selected and/or assigned missed approach procedure can be added to the display of the IAP as additional points, legs, and/or holding patterns beyond the landing runway.

Although not specifically illustrated, a similar decluttering process can be applied to displays of airport diagrams. Airport diagrams are used to reference the airport area. Airport diagrams include depictions of runways, taxiways, and other information to facilitate ground movement of aircraft between the aircraft stand and the runway. For large airports with complicated runway and taxiway layouts, the airport diagram can be quite cluttered. An airport diagram can be displayed with runway information that is referenced during approaches in addition to the airport layout and information pertinent to on-ground operations. Traditionally this information would have been supplied as a thumbnail on the approach chart and a separate airport diagram chart. In some embodiments, the airport diagram can be decluttered based on a selected and/or assigned taxi route such that the selected and/or assigned taxi route is displayed with information labels pertinent thereto being given priority in the display, while information labels associated with non-assigned taxiways and/or runways are given lower priority in the display. Priority ratings for information labels are described in more detail below.

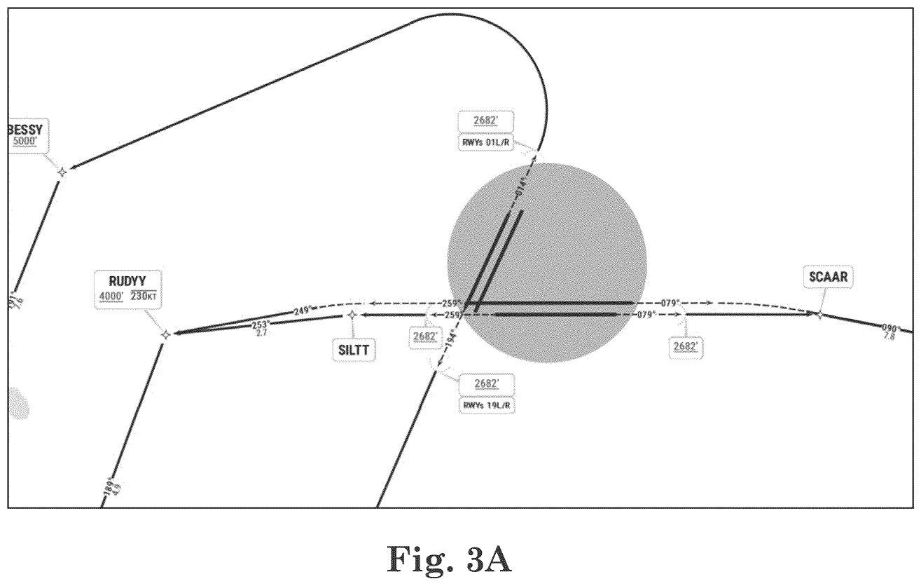

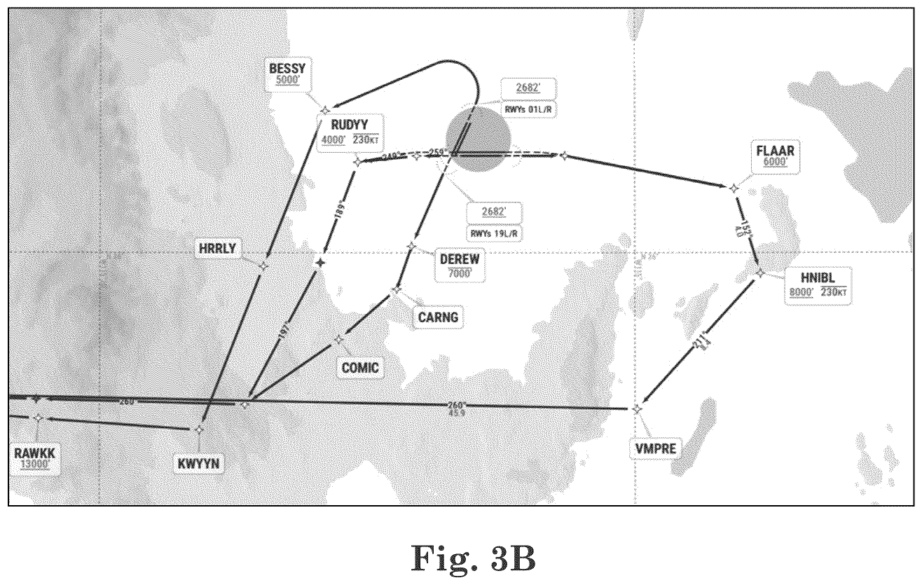

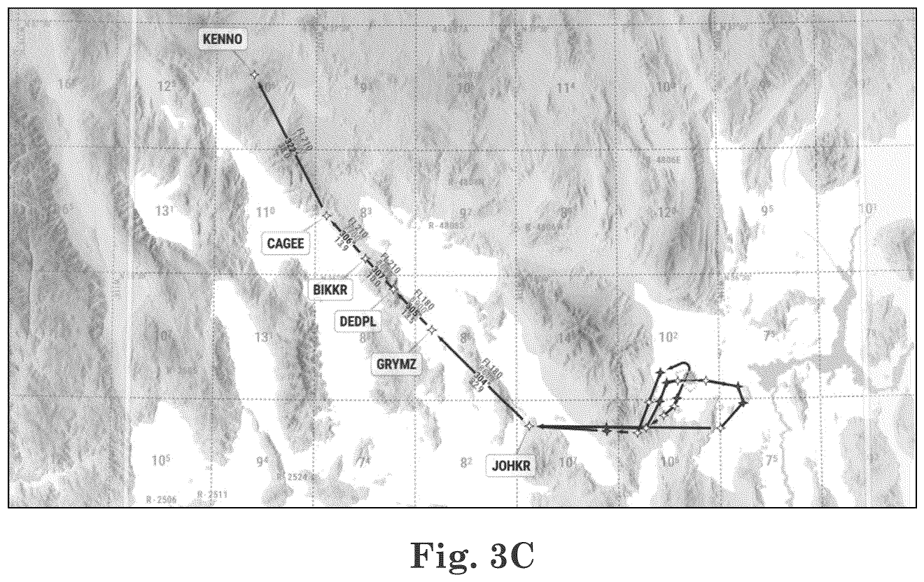

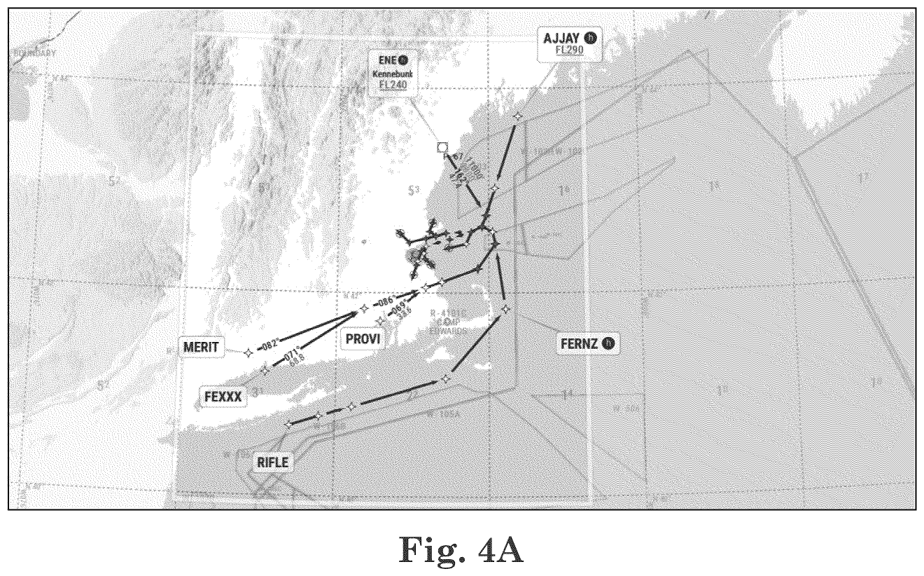

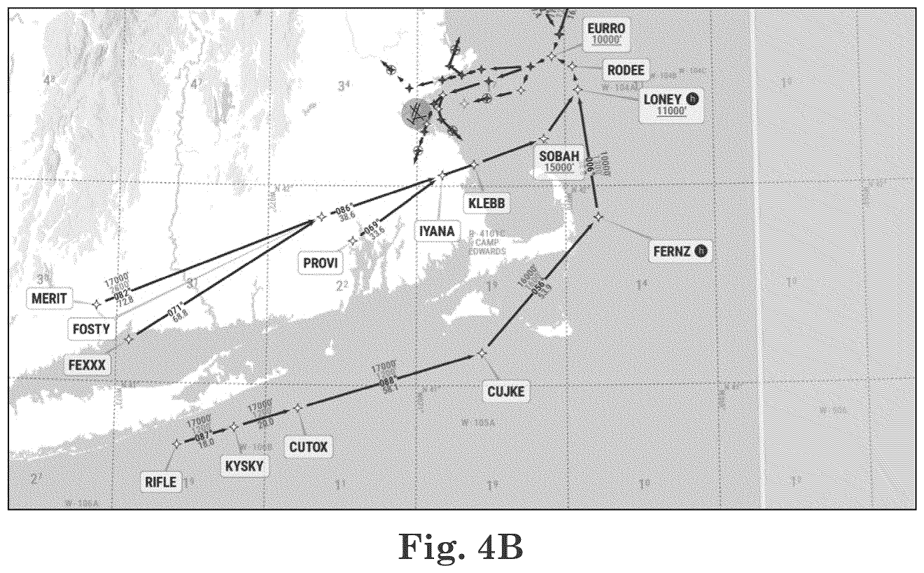

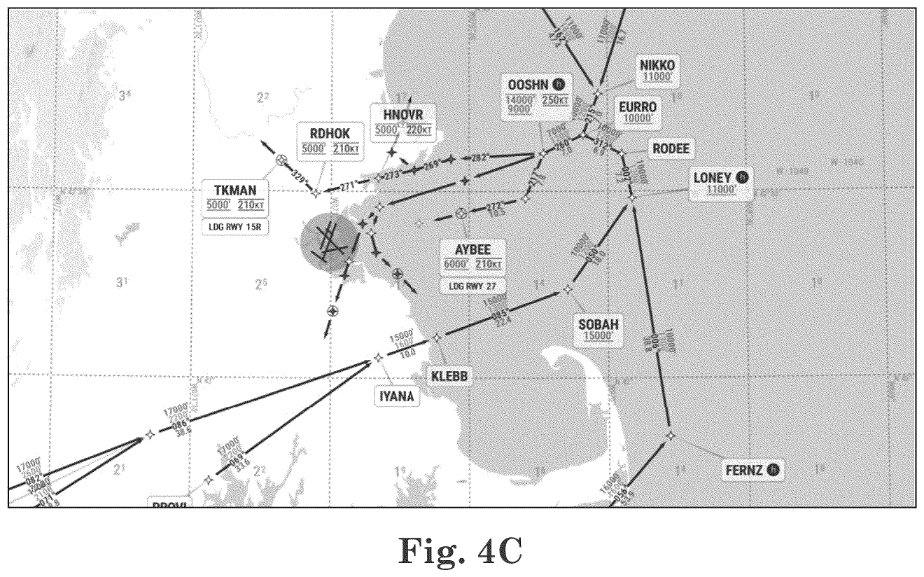

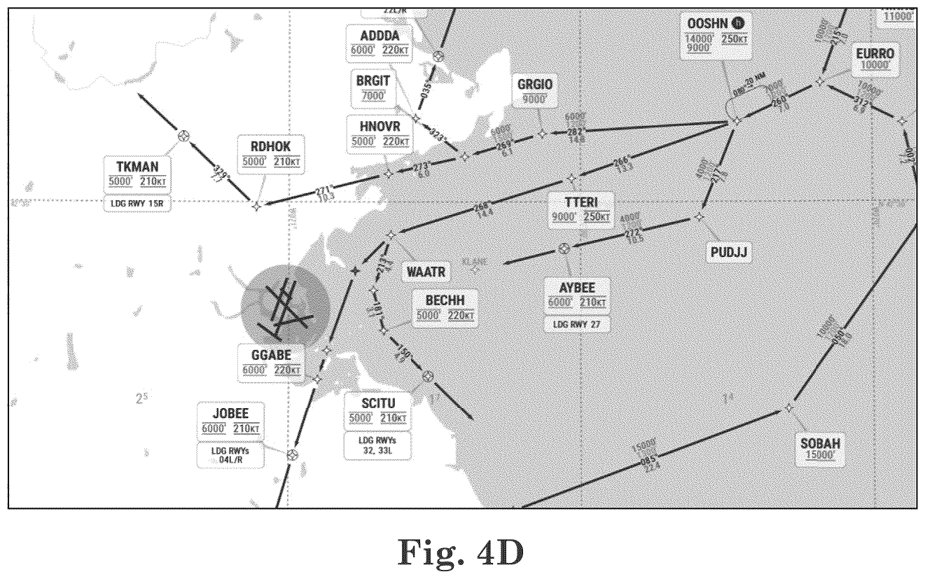

In at least one embodiment described herein, charted aviation procedures can be displayed in a plan view to-scale. In a to-scale rendering each procedural element can be dramatically different in size lending to challenges in being able to adequately label each element. Paper charts work around this by rendering problematic charts not to-scale by adjusting the sizes of the legs to be more uniform in length to improve the ability to adequately label each element. To ensure a natural and intuitive means of consistently displaying the procedural information to the user, each procedure can be broken up into contiguous sequences. The adequate zoom level for viewing the procedural information for each sequence is determined and propagated to each sequence in the procedure such that the elements displayed are decluttered sequentially and in order as the user briefs the procedure from start to finish. FIGS. 3A-3C illustrate this for a departure and FIGS. 4A-4D illustrate this for an arrival. Although not specifically illustrated, analogous sequential decluttering can also be applied to IAPs. IAPs start at one or more initial approach fixes, end at a runway, and contain a missed approach sequence. Approaches can be briefed by viewing the whole of the approach sequences leading to the runway with the missed approach being briefed separately.

FIG. 3A illustrates a display of initial legs of a charted aviation procedure known as the JOHKR FIVE departure from Harry Reid International Airport in Las Vegas at a zoomed in view. The JOHKR FIVE departure has been rendered to-scale and formatted in a more user-friendly style than the government chart. Departures start at one or more runways and end at one or more enroute transitions. Departures can be briefed by zooming into to see the geographically smaller procedure elements at the start of the procedure, followed by zooming out to see progressively larger elements with the smaller sequences of the procedure decluttering when the zoom level is too large to adequately support displaying each sequential portion of the procedure's information. The display illustrated in FIG. 3A is zoomed in to show the initial elements of the departure (e.g., runways, initial headings, initial altitude restrictions, and initial points) to scale. As illustrated, the initial points include BESSY, RUDYY, SILTT, and SCAAR. This allows the pilot to quickly and easily identify and learn the initial elements of the procedure to be flown. The system can be configured to display an initial leg of the departure on screen at a zoomed in view (as illustrated in FIG. 3A) and to display a subsequent leg of the departure on the screen at a zoomed out view (as illustrated in FIG. 3B or FIG. 3C) at least partially in response to completion of the initial leg being flown or in response to input from the pilot to change the display to a more zoomed out view (e.g., during briefing).

FIG. 3B illustrates a display of subsequent legs of the JOHKR FIVE departure at a less zoomed in view. Sequential decluttering for the departure can include decluttering (e.g., not displaying or minimizing) the procedural information associated with the initial legs as illustrated in FIG. 3B. Here, the assumption is that the briefing sequence or flight sequence has progressed beyond the initial leg, so the procedural information for the initial leg is less important to the pilot than the procedural information for the subsequent (e.g., intermediate) legs. Using the display illustrated in FIG. 3B the pilot can brief or fly the intermediate legs of the departure.

FIG. 3C illustrates a display of subsequent legs of the JOHKR FIVE departure at a zoomed out view. Sequential decluttering for the departure can include decluttering (e.g., not displaying or minimizing) the procedural information associated with the initial and intermediate legs as illustrated in FIG. 3C. As illustrated in FIG. 3C, the points from JOHKR to KENNO are displayed with point labels, but the previous points are not. The legs therebetween can be displayed with leg labels, but the previous legs are not. Here, the assumption is that the briefing sequence or flight sequence has progressed beyond the initial and intermediate legs, so the procedural information for the initial and intermediate legs is less important to the pilot than the procedural information for the subsequent (e.g., later) legs. Using the display illustrated in FIG. 3C the pilot can brief or fly the portion of the departure that leads to the enroute transition (e.g., the enroute transition point “KENNO” as illustrated). Although not specifically illustrated in FIGS. 3A-3C, the display can be further decluttered to display a selected portion to be flown while excluding portions not to be flown, analogously to the display illustrated in FIG. 2B. As should be appreciated, the leg label decluttering and the fixed label decluttering need not occur simultaneously and the decluttering functionality described herein may occur in any order.

FIG. 4A illustrates a display of a charted aviation procedure known as the OOSHN FIVE arrival to General Edward Lawrence Logan International Airport in Boston at a zoomed out view. The OOSHN FIVE arrival has been rendered to-scale and formatted in a more user-friendly style than the government chart. Arrivals start at one or more enroute transitions and end at one or more runways. Arrivals can be briefed by zooming out to see the geographically larger procedure elements at the start of the procedure, followed by zooming in to see the progressively smaller elements. The display illustrated in FIG. 4A is zoomed out to show the full procedure and enroute transitions, while the later to be flown sequences are decluttered. This allows the pilot to quickly and easily identify the desired enroute transition point (e.g., “FEXXX”) to start the arrival. The system can be configured to display the entire arrival on screen at a zoomed out view (as illustrated in FIG. 4A) and to display a subsequent legs of the arrival on the screen at more zoomed in views (as illustrated in FIGS. 4B-4D) at least partially in response to completion of the initial leg being flown or in response to input from the pilot to change the display to a more zoomed in view (e.g., during briefing).

FIG. 4B illustrates a display of the OOSHN FIVE arrival at a less zoomed out view. For example, more detail is displayed including points “FOSTY” after “FEXXX” as well additional leg information for the displayed legs. Initial sequences of the arrival are displayed, while later sequences (closer to the runways) are decluttered.

FIG. 4C illustrates a display of intermediate legs of the OOSHN FIVE arrival at an intermediate zoomed view. As illustrated in FIG. 4C, sequential decluttering for the arrival can include decluttering (e.g., not displaying or minimizing) the procedural information associated with the initial legs (e.g., RIFLE to CUJKE, which were illustrated in FIG. 4B) as well as the final legs (e.g.,, which are illustrated in FIG. 4D). Here, the assumption is that the briefing sequence or flight sequence has progressed beyond the initial leg, so the procedural information for the initial leg is less important to the pilot than the procedural information for the subsequent (e.g., intermediate) legs. Likewise, the final legs have not yet been reached, so they are less important. Using the display illustrated in FIG. 4C the pilot can brief or fly the intermediate legs of the arrival.

FIG. 4D illustrates a display of final legs of the OOSHN FIVE arrival at a zoomed in view. The display is zoomed in further to see most or all of the final sequences without those sequences being decluttered. Although not specifically illustrated in FIGS. 4A-4D, the display can be further decluttered to display a selected portion to be flown while excluding portions not to be flown, analogously to the display illustrated in FIG. 2B.

Although not specifically illustrated, a similar sequential decluttering process can be applied to displays of an IAP. A selected portion of an IAP to be flown can include legs and points corresponding to an initial approach fix, landing runway, and missed approach sequence. An initial leg of the IAP can be displayed on the screen at a zoomed out view and a subsequent leg of the IAP can be displayed on the screen at a zoomed in view at least partially in response to completion of the initial leg.

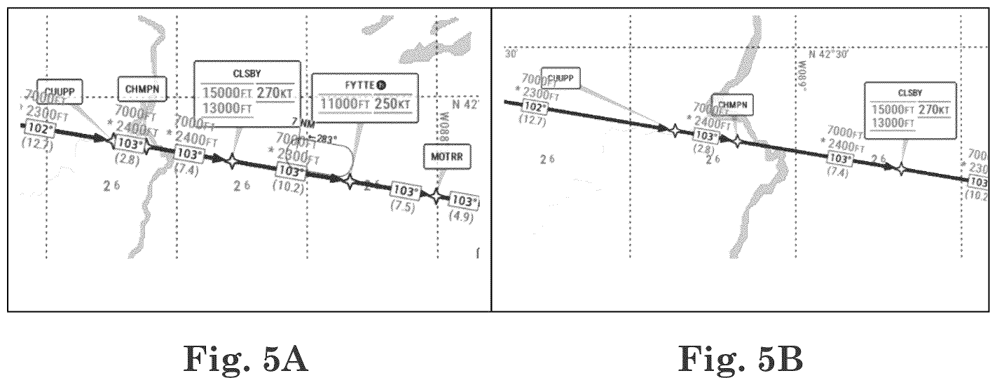

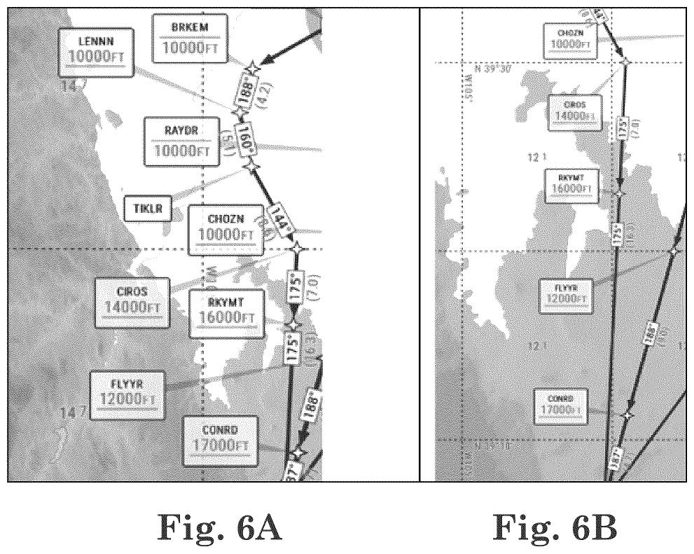

FIG. 5A illustrates a display of intermediate legs of a charted aviation procedure known as the FYTTE SEVEN arrival into Chicago O'Hare International Airport at a zoomed out view. FIG. 5B illustrates a display of intermediate legs of the FYTTE SEVEN arrival at a zoomed in view. FIG. 6A illustrates a display of several legs of a charted aviation procedure known as the SUDDZ ONE departure from Denver International Airport at a zoomed out view. FIG. 6B illustrates a display of several legs of the SUDDZ ONE departure at a zoomed in view. The FYTTE SEVEN arrival and the SUDDZ ONE departure have been rendered to-scale and formatted in a more user-friendly style than the government chart. FIGS. 5A-6B help facilitate explanation of the operation of the dynamic label placement logic described herein.

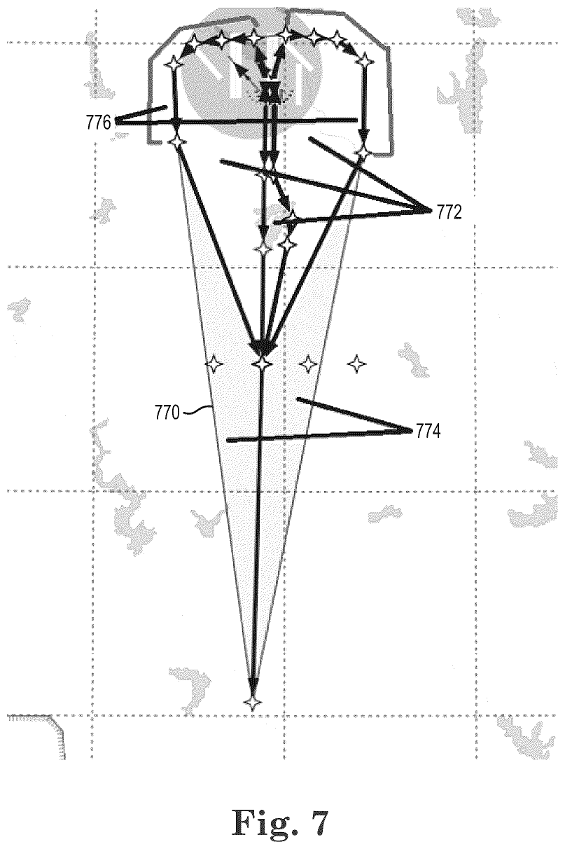

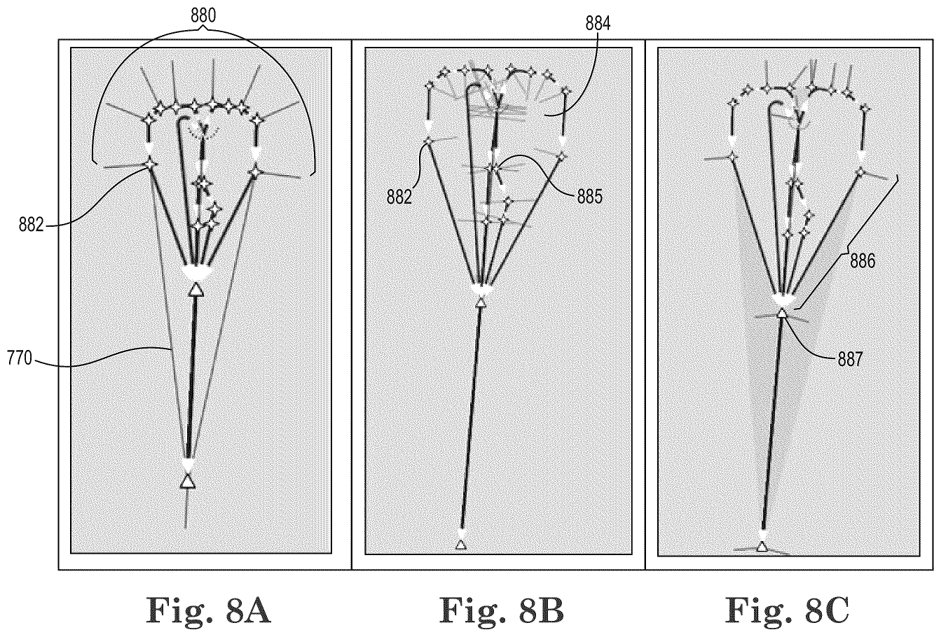

As illustrated in FIG. 5A, and described in more detail below with respect to FIGS. 7-8C, information labels fan out to make use of available space in a zoomed out view. As illustrated in FIG. 5B, in a more zoomed in view, the information labels remain at a same geographic position, but they are moved as close as possible to their preferred placement (e.g., near the corresponding point).

As illustrated in FIG. 6A, and described in more detail below with respect to FIGS. 7-8C, interweaving is applied in highly congested areas. As illustrated in FIG. 6B, popped out information labels move closer to the procedure when there is sufficient space. Such movement can be smooth.

When the view of a segment of a chart changes by zooming out or in, the information labels can move. For example, a leg label can be decluttered by moving along the corresponding leg between adjacent points to avoid collisions with point labels. Movement of a point label while changing zoom in one direction (in or out) will occur in a same direction (in or out) from the corresponding point. For successively zoomed out views, decluttering a point label can include moving it in a respective direction away from or toward the corresponding point. For example, zooming out from the display illustrated in FIG. 6B to the display illustrated in FIG. 6A, the point label “CIROS” (the text box) moves farther southwest of the point it identifies. Such movement of point labels can also be constrained such that the text boxes for the point labels are displayed on a same side of the leg, regardless of zoom. By way of example, in FIGS. 5A-5B, the text boxes for the point labels CUUPP, CHMPN, and CLSBY are on the north side of the corresponding legs for both the zoomed in and zoomed out views. Likewise, in FIGS. 6A-6B, the text boxes for the point labels CONRD, FLYYR, RKYMT, CIROS, and CHOZN are on the west side of the corresponding legs in both the zoomed in view and the zoomed out view. The point labels do not cross the leg when the zoom changes.

As used herein, the term “graph” describes everything in a chart that is scaled based on real-world geometry in the to-scale rendering. As the view zooms in and out, the graph takes up more or less of the screen. For example, a leg displayed on the screen will grow for a zoomed in view. As the view zooms in and out, point labels take up the same amount of space on the screen. Point labels can be scaled, but this is based on a label placement scaling algorithm rather than being in unison with the elements scale based on real-world geometry.

As used herein “meters per pixel” (MPP) describes the current zoom scale of a graph during a given render cycle. Specifically, it tracks the number of meters that fit in the length of one pixel at the current zoom level. A higher MPP means the user is more zoomed out than at a lower MPP.

A pre-determined list of potential placements can be generated for each information label based on the geometry of the procedure and potential interactions with other point labels. The geometry of the graph is first analyzed, splitting the space in the chart into distinct sections separated by graph edges. A placement where the label will fit at its worst-case size relative to the graph is determined for each label through a global two-dimensional optimization algorithm, where the two dimensions are (1) information label crowding and clutter and (2) individual information label movement in order to reach its worst-case placement. Both dimensions are minimized, resulting in a worst-case placement for each label that optimizes organization. Notably, worst-case placements are dependent on stats/priority decluttering. Since higher priority and/or less crowded branch labels are on-screen at higher MPPs, their worst-case placements tend to be in the larger geometric spaces in or around the graph.

Once a worst-case placement has been determined, the rest of the placements are generated. A preferred placement is chosen for each point label (e.g., directly next to the corresponding point). The preferred placement is chosen in keeping with the constraint for the point label to move in a same direction from the corresponding point, so the placement puts the point label next to the point in the general direction of the worst-case placement. Intermediate placements are added between the worst-case and ideal placements if necessary, so that the label can move through the different placements as the user zooms in and out. The now completed dynamic label placement logic transitions to display conflict resolution logic for resolving display conflicts with a blueprint to avoid collisions with the procedure elements in a manner that minimizes confusion by limiting the point label's movement to be within the same general direction out from the point. Display conflicts include collisions, obscurations, and overlap of information labels.

Information labels can move smoothly to avoid collisions with procedure elements and other information labels. Sudden jumps of the position of an information label is avoided so that the user's eye can easily track the movement of the information label as the zoom changes.

To promote smoothness, movement directions within the geometric shape can be pre-determined for each placement, and runtime logic moves the point labels in the pre-determined direction to resolve display conflicts such as collisions. In order to determine the movement direction of the point labels, each shape is analyzed for areas with increased point label crowding. Clusters of point labels are identified by modeling the point labels as having charges that repel each other, and each label is given a movement direction away from the nearest point label cluster. Since the movement is pre-determined, display conflict resolution logic moves the point labels to avoid collision without sudden jumps.

Point labels are placed in a manner that maintains organization, readability, and prioritization of highly important information. To achieve this, a pre-determined placement list is chosen for each point label. At runtime, a point label can be moved between placements to avoid collisions with the graph. Higher priority point labels are more likely to get a more optimal placement list. A movement direction can be determined for each placement. At runtime, collisions with other point labels are resolved by moving in the determined movement direction. Point labels can be scaled proportionally to the priority rating of the information in the information label or of the information label itself.

Each information label can have a respective priority rating. The priority ratings provide a relative importance for each information label. Such priority ratings can be predetermined and built into the runtime logic and/or can be set by a user. Thus, one information label may be prioritized over another. For example, the point label for a final approach fix on an IAP may have a higher priority rating than a point label for a step down fix. In this example, during decluttering, the point label for the step down fix would be decluttered before or more aggressively than the point label for the final approach fix. Furthermore, individual components of an information label may have different priority ratings. By way of example with respect to leg labels, heading information may have a higher priority than distance information, which may have a higher priority than altitude information. When an information label is being decluttered, the lower priority information can be excluded from the information label before the higher priority information. The runtime logic can prevent higher priority information labels from being occluded or made less readable in order to display lower priority information labels. Information labels can be decluttered for a zoomed out view and resulting display conflicts (from the zoomed out view) can be resolved between the information labels in favor of those with a relatively higher priority rating.

Resolving display conflicts for point labels can include displaying a foreground text box of a higher priority point label on the screen partially overlapping a background text box of a lower priority point label without obscuring text of either text box. The text of a higher priority leg label can be displayed over a text box of a lower priority point label such that the text of the leg label is displayed over the text box of the point label. For example, in FIG. 5A, one text string associated with the leg label prior to the point CUUPP is displayed as “7000 ft” over the text box for the point label associated with CUUPP. This allows the user to see the more important information associated with the leg more easily than the name of the point CUUPP (although both are visible).

Aside from the prioritization of higher-priority information labels in placement stack generation mentioned above, remaining display conflicts persisting after operation of the display conflict resolution logic are handled by decluttering lower-priority information labels. Once information labels are placed during a given render cycle, conflicts may remain if an area is crowded with many labeled points whose point labels need to be on screen at the current MPP. In the case that a conflict between two labels is detected, the lower-priority point label is decluttered (scaled, excluded, partially excluded, etc.) to make room for the higher-priority point label to show at full size. If the point labels have the same priority, they are scaled equally, with the exception of high priority information labels, which never scale. To resolve a display conflict, an information label or a portion thereof can be excluded from the display. For example, a leg label having multiple text strings can be decluttered by excluding one or more of the text strings. Excluding a text string for a leg label can be done, for example, in response to the leg label having a relatively lower priority rating than a conflicting information label. In some embodiments, each text string in a leg label can have a respective priority rating and can be decluttered accordingly. For example, a text string having a lowest relative priority rating can be excluded first during decluttering. High priority information labels can be predefined or user defined. For example, the point label for a final approach fix on an IAP may be defined as a high priority label. In some embodiments, high priority information labels can be displayed on the screen in a same geographic location in a zoomed out view and in a zoomed in view. In some embodiments, high priority information labels are not excluded from the display. In such embodiments, high priority information labels may be decluttered by scaling or moving, but not by exclusion from the display. Information labels that have scaled too small to be readable are decluttered. In this way, higher priority labels stay legible and visible for as long as possible, while lower priority labels scale and declutter sooner to make room.

Leg labels can be placed at a static position that minimizes text clutter and reduces display conflicts with neighboring legs. The maximum size of the leg label is determined by the shortest leg on a given sequence of contiguous legs of a charted aviation procedure. A geometry analysis is done to determine the nearest legs within the maximum size of the label. A horizontal position is chosen that optimizes perpendicular space between nearest neighboring legs. In the case of collinear or near-collinear legs, a vertical offset is applied to keep label information visible and prevent decluttering in later steps.

A vertical offset may also be applied in areas of tight geometry in the sequence of contiguous legs. This prevents the user from having to zoom in excessively to populate leg label data along the group of contiguous legs. The resulting leg label placement minimizes colliding leg labels and optimizes the length of time the leg labels are visible.

Similarly, leg labels adhere to priority decluttering that allows a sequence of high priority labels or components (portions of labels) to be displayed before low priority components. The decluttering of low priority components increases space available for high priority components, ensuring high priority data stays visible for as long as possible. To prevent aggressive decluttering resulting from tight procedure geometries in one area of the sequence, a vertical offset is applied in the direction of the greatest perpendicular space. Since priority decluttering is synced across the sequence of contiguous legs, the number of times decluttering occurs is minimized and restricted to the group of contiguous legs. The effect is reduced cognitive load on the user.

By way of example, an order of priority ratings for point labels associated with a departure or arrival follows: high priority for any point that is an enroute transition; medium priority for any point with a speed or altitude constraint; and low priority for all other points. By way of example, an order of priority ratings for point labels associated with an IAP is given: high priority for the initial approach fix, final approach fix, and localizer feather; 2nd priority for the intermediate fix and runway, 3^{rd} priority for speed and altitude constraints, and 4^{th} priority for points for the missed approach or other points. By way of example, an order of priority ratings for leg labels is given: high priority for bearing or airway identifiers, 2^{nd} priority for altitude constraints, 3^{rd} priority for distance, 4^{th} priority for secondary altitude constraints, 5th priority for notes, and 6^{th} priority for ARINC lines (ARINC is a data transfer standard for aircraft avionics).

Various embodiments of the present invention described herein may be implemented as a stateless solution. In such embodiments, the content displayed in the current render frame is not dependent on what was shown in any previous render frame. Instead, metadata for the entire charted aviation procedure is loaded in advance of display, allowing the rendering logic for each frame to execute instructions based solely on the preloaded metadata. This stateless approach may be employed for any or all aspects of the invention, including, but not limited to, label decluttering, leg label placement, and point label placement. In a stateless system, all display behavior is pre-determined, as opposed to a state-based system where the appearance of the display at a given zoom level may differ depending on prior user interactions or display states. For example, in a state-based system, zooming into a map and then zooming out to the original zoom level could result in a different label placement than initially displayed. Such variability may be undesirable from a user perspective. In contrast, embodiments of the present invention that implement a stateless solution ensure a uniform and consistent display experience for the pilot, thereby reducing pilot workload. For instance, each time the pilot returns to the same zoom level, the display will remain consistent, with identical label placements and visual elements, regardless of prior interactions.

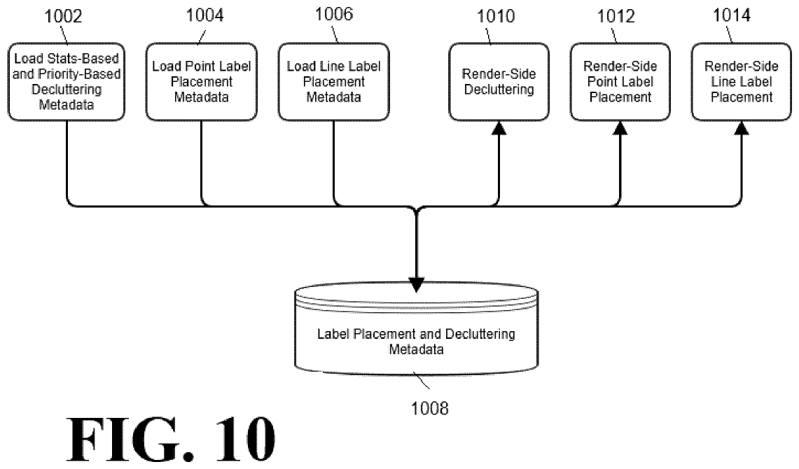

FIG. 10 illustrates an exemplary stateless architecture for label placement and decluttering provided by various embodiments of the present invention. As shown, various types of metadata are loaded in advance of display, forming the foundation for the stateless rendering process. Specifically, the system loads metadata for state-based and priority-based decluttering, point label placement, and line (or leg) label placement. Each of these metadata sets is precomputed and stored within a central repository of label placement and decluttering metadata. This preloading ensures that the rendering logic can access all necessary information without relying on prior frames, thereby implementing a fully stateless solution.

The “Load Stats-Based and Priority-Based Decluttering Metadata” block 1002 represents the process of loading metadata that governs the decluttering logic based on label priority and geometric constraints. As described in previous sections, each information label is assigned a priority rating, with higher-priority labels being given preference during decluttering. This metadata ensures that during rendering, labels are displayed in an organized manner, with critical information being prominently displayed and lower-priority information being decluttered as necessary.

The “Load Point Label Placement Metadata” block 1004 and “Load Line Label Placement Metadata” block 1006 illustrate the loading of metadata that governs the placement of point labels and line (leg) labels, respectively. Point labels correspond to specific points on the charted aviation procedure, such as waypoints, navaids, or fixes, and are placed according to precomputed positions that avoid overlap with other labels while maintaining proximity to their corresponding points. Similarly, line labels provide procedural information for flight legs, such as headings, distances, and altitude restrictions, and are placed along the legs in positions that minimize clutter and maintain readability.

All loaded metadata may be stored in the central “Label Placement and Decluttering Metadata” repository 1008. This repository acts as a source of truth during the rendering process, ensuring that each frame is generated based on the same underlying data. This approach eliminates inconsistencies that could arise in a state-based system, where the display could be influenced by previous frames or user interactions.

FIG. 10 also illustrates an example rendering process including processes for decluttering, point label placement, and line label placement. The “Render-Side Decluttering” block 1010 applies the preloaded decluttering metadata to determine which labels are displayed, hidden, or scaled based on the current zoom level and label priority. The “Render-Side Point Label Placement” block 1012 and “Render-Side Line Label Placement” block 1014 utilize the preloaded placement metadata to position labels accurately and consistently in every frame.

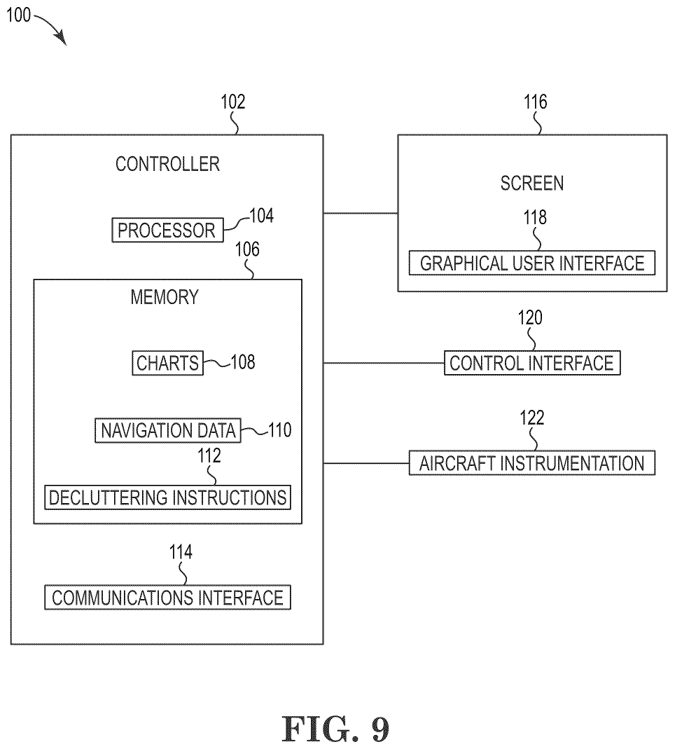

The stateless process described herein may be implemented using various components of the system 100, as illustrated in FIG. 9 and described in more detail below. For example, the processor 104 is configured to execute the instructions for label placement and decluttering stored in the non-transitory computer-readable storage medium (e.g., memory 106). The memory 106 stores electronic representations of charts 108 and navigation data 110, along with the decluttering instructions 112 that provide the logic for the stateless system. The metadata for state-based and priority-based decluttering, point label placement, and line label placement may be preloaded into memory 106 prior to rendering, ensuring that each frame is generated independently. The processor 104 accesses this metadata from memory 106 and applies it during runtime to dynamically place labels and declutter the display, as described above. Additionally, the system's graphical user interface 118 and screen 116 display the rendered charted aviation procedures, with the control interface 120 allowing pilots to interact with the system without altering the preloaded metadata, thus maintaining the stateless nature of the display

FIG. 7 illustrates a generic charted aviation procedure with various regions identified for geometry processing. The chart points, legs, runways, and makeups are processed into a graph data structure. The convex hull 770, an outer shell around the points in the procedure, is calculated. The area inside the convex hull 770 is divided into distinct regions including cutouts 772 and inlets 774. Cutouts 772 are regions that are completely enclosed by edges in the graph. Inlets 774 are regions that have an opening out of the procedure. The convex hull 770 itself is also divided into distinct hull sections 776, which are a series of connected points along the outside of the procedure. Once each information label has been moved into a region where it will fit, the labels in each inlet and hull section 776 are fanned out. Information labels are given a bearing that slides along the shape to make room for one another.

FIG. 8A illustrates information label placement vectors 880 associated with the generic charted aviation procedure. For the convex hull 770, the information label placement vectors 880 are calculated pointing outwards from each vertex 882 of the polygon.

FIG. 8B illustrates inlets vectors 884 associated with the generic charted aviation procedure. The inlets vectors 884 are calculated pointing into the interior of the polygon from each vertex 882 of the polygon and from each interior point 885 within the polygon.

FIG. 8C illustrates cutout vectors 886 associated with the generic charted aviation procedure. The cutout vectors 886 are calculated similarly to the information label placement vectors 880, but are calculated for each vertex 882 of the polygon and for points 887 associated with the inlets 774.

It is to be understood that the terms “user” and “pilot” are used interchangeably herein to describe any pilot, co-pilot, crew member, or other person who operates or controls the aircraft and/or user interface.

FIG. 9 is a block diagram of a system 100 for decluttering an aviation navigation display. A flight deck system can include electronic devices, such as integrated avionics systems, which are utilized by one or more aircraft operators (e.g., a pilot and/or a co-pilot) to navigate an aircraft. Integrated avionics systems may employ primary flight display(s) (PFDs), multifunction display(s) (MFDs), and electronic flight bags (EFBs) to furnish primary flight control, navigational, and other information to the flight crew of the aircraft. Additionally, the integrated avionics systems may also employ an avionics control and display unit (CDU), portable electronic devices (PEDs), applications, and/or other control devices that are configured to provide control functionality to the PFDs, the MFDs, and/or the EFBs.

The system 100 can be an integrated avionics system for an aircraft. The system 100 generally includes a controller 102 having a processor 104, non-transitory computer-readable storage medium (e.g., memory 106), and a communications interface 114. The memory 106 stores electronic representations of charts 108, navigation data 110, and computer executable instructions 112 for execution by the processor 104 to declutter an aviation navigation display on the screen 116, among other functions described herein. Each of the electronic representations of charts 108 describes one or more charted aviation procedures and information for operating an aircraft according to the charted aviation procedure.

The screen 116 is capable of providing a graphical user interface 118. The system further includes a control interface 120. In some embodiments, the graphical user interface 118 and control interface 120 can be combined into a single device. The graphical user interface 118 and/or control interface 120 can allow a pilot (e.g., pilot, co-pilot, and/or other aircraft operator) to provide input. In some embodiments, the graphical user interface 118 and/or control interface 120 is a touch screen interface, such as an electronic visual display that incorporates a touch panel overlying an electronic display to detect the presence and/or location of a touch within the display area of the screen 116. In these embodiments, the pilot can provide input using an instrument such as a finger, a stylus, and so forth. In some embodiments, the graphical user interface 118 and/or control interface 120 allows the pilot to provide non-touch input via one or more keyboards, cursors, buttons, knobs, dials, control columns, and so forth. The graphical user interface 118 and/or control interface 120 can receive a selection, for example, of a portion of a charted aviation procedure to be flown. In response to the selection, the processor 104 is operable to declutter information labels for a zoomed out view of the chart 108 and resolve resulting display conflicts between information labels in favor of those with a relatively higher priority rating.

The screen 116 can be a liquid crystal display (LCD), a thin film transistor (TFT), a light emitting polymer (LEP) or light emitted diode (LED), and so forth, configured to display text and/or graphical information. The screen 116 can be backlit via a backlight such that it can be viewed in the dark or other low-light environments. In some embodiments, the graphical user interface 118 can be disposed on an instrument panel of the aircraft, a pedestal area of the aircraft, an outboard area of the aircraft, and so forth. In embodiments, the system 100 can include one or more graphical user interfaces 118 with corresponding displays for providing differing functionality including, but not limited to: PFD(s), MFD(s), head up display(s) (HUDs), secondary display unit(s) (SDUs), CDU(s), PED(s), electronic flight bag(s) (EFBs), and so forth. The graphical user interface 118 may furnish a general-purpose pilot interface to control the aircraft's avionics. For example, the graphical user interface 118 allow the pilot to control various systems of the aircraft such as the aircraft's flight management system, autopilot system, navigation systems, communication systems (e.g., controller pilot data link communications system (CDPLC), automatic dependent surveillance-broadcast (ADS-B), aircraft communications addressing and reporting system (ACARS), airborne satellite communications systems (SATCOM), other data link systems, other ground-ground communication systems, etc.), engines, and so on, via the avionics data bus. In implementations, the avionics data bus may include a high-speed data bus (HSDB), such as data bus complying with ARINC 429 data bus standard promulgated by the Airlines Electronic Engineering Committee (AEEC), a MIL-STD-1553 compliant data bus, and so forth.

The control interface 120 can be coordinated with the graphical user interface 118 for entry of data and commands. In embodiments including a touch screen interface, the operator may use his or her fingers to manipulate images and/or selectable items on the graphical user interface 118. The control interface 120 can be disposed on the graphical user interface 118, external to the graphical user interface 118, or a combination thereof. In some embodiments, the graphical user interface 118 is operable by a combination of direct touch received via the touch screen interface and input received external to the graphical user interface 118.

Examples of the touch surface include a resistive touch screen, a surface acoustic wave touch screen, a capacitive touch screen, an infrared touch screen, optical imaging touch screens, dispersive signal touch screens, acoustic pulse recognition touch screens, combinations thereof, and the like. Capacitive touch screens can include surface capacitance touch screens, projected capacitance touch screens, mutual capacitance touch screens, and self-capacitance touch screens. In implementations, the touch surface is configured with hardware to generate a signal to send to a processor and/or driver upon detection of touch information (e.g., a touch input). As indicated herein, touch inputs include inputs, gestures, and movements where the input contacts the touch surface. The touch screen interface can receive touch information from an operator (e.g., user such as a pilot and/or a co-pilot) to interact with the graphical user interface 118 displayed on the screen 116. In some embodiments, the touch screen interface may include both active portions (e.g., areas that are responsive to operator touch information) and non-active portions (e.g., areas that are not responsive to operator touch information). In implementations, keyboards, cursors, buttons, softkeys, keypads, knobs and so forth, may be used for entry of data and commands instead of or in addition to the touch surfaces.

The graphical user interface 118 is configured for displaying flight information. In some embodiments, the flight information includes information related to a flight plan and/or charts 108 for the aircraft. As described herein, flight information can include a decluttered aviation navigation display. In some embodiments, the flight-related information is displayed in one or more primary flight windows (PFWs), one or more multifunction windows (MFWs), or a combination thereof. The PFWs may be configured to display primary flight information, such as aircraft attitude, altitude, heading, vertical speed, and so forth.

In embodiments, the PFWs may display primary flight information via a graphical representation of basic flight instruments (included in the aircraft instrumentation 122) such as an attitude indicator, an airspeed indicator, an altimeter, a heading indicator, a course deviation indicator, and so forth. The PFWs may also display other flight-related information providing situational awareness to the pilot such as terrain information, ground proximity warning information, weather information, and so forth.

The MFWs display interactive flight-related information describing operation of the aircraft such as navigation routes, moving maps, engine gauges, weather radar, terrain alerting and warning system (TAWS) displays, ground proximity warning system (GPWS) displays, traffic collision avoidance system (TCAS) displays, airport information, and so forth, that are received from a variety of aircraft systems via the avionics data bus and/or are self-contained within the graphical user interface 118. In some embodiments, the PFW may provide the functionality of an MFW. Where the system 100 includes multiple MFWs, MFWs that control a common systemwide value/state can be cross-filled when multiple instances viewing this value are active substantially simultaneously. Further, the graphical user interface 118 may be capable of displaying multiple instances of the same application in multiple MFWs, for example, with no restrictions on the number of the same application that could be displayed substantially simultaneously. In some embodiments, MFWs and/or PFWs shall support display and/or control of third-party applications (e.g., video, hosted applications, ARINC 661, etc.).

In embodiments, the EFB displays interactive flight-related information in a similar manner to MFWs and/or PFWs described above, but in a portable and self-contained format. The EFB may be a specific-purpose portable electronic device or an application running on a conventional electronic device such as a tablet computer or smartphone.

The controller 102 provides functionality to the graphical user interface 118 via the processor 104, the communications interface 114, and the memory 106. The processor 104 can be operably and/or communicatively coupled with the graphical user interface 118 and/or the control interface 120. The processor 104 can control the components and functions of the system 100 described herein using software, firmware, hardware (e.g., fixed logic circuitry), manual processing, or a combination thereof. The terms “controller,” “functionality,” “service,” and “logic” as used herein generally represent software, firmware, hardware, or a combination of software, firmware, or hardware in conjunction with controlling the system 100. In the case of a software implementation, the module, functionality, or logic represents program code that performs specified tasks when executed on a processor (e.g., central processing unit (CPU) or CPUs). The program code can be stored in one or more computer-readable memory devices (e.g., internal memory and/or one or more tangible media), and so on. The structures, functions, approaches, and techniques described herein can be implemented on a variety of commercial computing platforms having a variety of processors.

The processor 104 provides processing functionality for the system 100 and can include any number of processors, micro-controllers, or other processing systems, and resident or external memory for storing data and other information accessed or generated by the system 100. The processor 104 can execute one or more software programs that implement techniques described herein. The processor 104 is not limited by the materials from which it is formed or the processing mechanisms employed therein and, as such, can be implemented via semiconductor(s) and/or transistors (e.g., using electronic integrated circuit (IC) components), and so forth.

The communications interface 114 is operatively configured to communicate with components of the system 100. For example, the communications interface 114 can be configured to transmit data for storage in the system 100, retrieve data from storage in the system 100, and so forth. The communications interface 114 is also communicatively coupled with the processor 104 to facilitate data transfer between components of the system 100 and the processor 104 (e.g., for communicating inputs to the processor 104 received from a device communicatively coupled with the system 100). It should be noted that while the communications interface 114 is described as a component of a system 100, one or more components of the communications interface 114 can be implemented as external components communicatively coupled to the system 100 via a wired and/or wireless connection. The system 100 can also include and/or connect to one or more input/output (I/O) devices (e.g., via the communications interface 114), including, but not necessarily limited to: a display, a mouse, a touchpad, a keyboard, and so on.

The communications interface 114 and/or the processor 104 can be configured to communicate with a variety of different networks, including, but not necessarily limited to: ARINC 429; RS-232; RS-422; CAN Bus; ARINC 661; a wide-area cellular telephone network, such as a 3G cellular network, a 4G cellular network, a 5G cellular network, or a global system for mobile communications (GSM) network; a wireless computer communications network, such as a Wi-Fi network (e.g., a wireless local area network (WLAN) operated using IEEE 802.11 network standards); an internet; the Internet; a wide area network (WAN); a local area network (LAN); a personal area network (PAN) (e.g., a wireless personal area network (WPAN) operated using IEEE 802.15 network standards); a public telephone network; an extranet; an intranet; and so on. However, this list is provided by way of example only and is not meant to limit the present disclosure. Further, the communications interface 114 can be configured to communicate with a single network or multiple networks across different access points. The communications interface 114 can facilitate integration of aircraft alerts and/or notifications (e.g., notice to air missions (NOTAM), National Oceanic and Atmospheric Administration (NOAA) weather alerts, weather ship alerts, Safety Alerts, air-ground communications, etc.) with system 100.

The memory 106 is an example of tangible, computer-readable storage medium that provides storage functionality to store various data associated with operation of the system 100, such as software programs and/or code segments, or other data to instruct the processor 104, and possibly other components of the system 100, to perform the functionality described herein. Thus, the memory 106 can store data, such as a program of instructions for operating the system 100 (including its components), and so forth. It should be noted that while a single memory 106 is described, a wide variety of types and combinations of memory (e.g., tangible, non-transitory memory) can be employed. The memory 106 can be integral with the processor 104, can include stand-alone memory, or can be a combination of both.

The memory 106 can include, but is not necessarily limited to: removable and non-removable memory components, such as random-access memory (RAM), read-only memory (ROM), flash memory (e.g., a secure digital (SD) memory card, a mini-SD memory card, and/or a micro-SD memory card), magnetic memory, optical memory, universal serial bus (USB) memory devices, hard disk memory, external memory, and so forth. In implementations, the system 100 and/or the memory 106 can include removable integrated circuit card (ICC) memory, such as memory provided by a subscriber identity module (SIM) card, a universal subscriber identity module (USIM) card, a universal integrated circuit card (UICC), and so on. In embodiments, the memory 106 includes one or more software modules capable of being executed by the processor 104, and one or more data sets and/or databases. In embodiments, the memory 106 includes one or more software modules capable of being executed by the processor 104, and one or more data sets and/or databases.

The memory 106 is operable to store a database of flight-related information associated with a flight plan and/or charts 108 for an aircraft. In some embodiments, flight-related information includes electronic representations of charts 108 (e.g., IAPs, airport diagrams, departures, arrivals, charted visual flight procedure charts, etc.) describing procedures and information for operating the aircraft under specified circumstances (e.g., in proximity to an airport). Navigation data 110 can include navigation data, terrain data, and/or obstacle data, which can be interfaced with data from the aircraft instrumentation 122. Navigation data 110 can include additional data related to the operation of the aircraft.

The system 100 can include aircraft instrumentation 122, such as a position determining system that may include a global navigation satellite system (GNSS) receiver, such as a global positioning system (GPS) receiver, or the like, and a satellite communication unit, and so forth. The aircraft instrumentation 122 can include other flight related components for providing aircraft information, controlling the aircraft, retrieving data from memory 106, and so on. The position determining system may comprise a receiver that is configured to receive signals from one or more position-transmitting sources. For example, the position determining system may be configured for use with a GNSS. In embodiments, the position determining system may be a GPS receiver operable to receive navigational signals from GPS satellites and to calculate a location of the aircraft as a function of the signals. Other exemplary position-determining systems include, but are not limited to, a Global Orbiting Navigation Satellite System (GLONASS), a Galileo navigation system, and/or other satellite or terrestrial navigation systems.

The term “computer-readable storage medium” should be taken to include a single medium or multiple media that store the one or more sets of instructions. The term “computer-readable storage medium” shall also be taken to include any medium that is capable of storing or encoding a set of instructions for execution by a processor and that cause a device to perform any one or more of the methodologies of the present disclosure. The term “computer-readable storage medium” shall accordingly be taken to include, but not be limited to, solid-state memories, optical media, and magnetic media, whether provided in a local or distributed manner (e.g., cloud storage).

Although specific embodiments have been illustrated and described herein, those of ordinary skill in the art will appreciate that an arrangement calculated to achieve the same results can be substituted for the specific embodiments shown. This disclosure is intended to cover adaptations or variations of one or more embodiments of the present disclosure. It is to be understood that the above description has been made in an illustrative fashion, and not a restrictive one. Combination of the above embodiments, and other embodiments not specifically described herein will be apparent to those of skill in the art upon reviewing the above description. The scope of the one or more embodiments of the present disclosure includes other applications in which the above structures and methods are used. Therefore, the scope of one or more embodiments of the present disclosure should be determined with reference to the appended claims, along with the full range of equivalents to which such claims are entitled.

As used herein, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected and, unless stated otherwise, can include a wireless connection. As will be appreciated, elements shown in the various embodiments herein can be added, exchanged, and/or eliminated so as to provide a number of additional embodiments of the present disclosure.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A system for decluttering an aviation navigation display, comprising:
a screen;
a processor coupled to the screen; and
a memory coupled to the processor and storing instructions executable by the processor to:
display on the screen, with a plurality of information labels, a selected portion to be flown of a charted aviation procedure and exclude an unselected portion not to be flown;
wherein the plurality of information labels have priority ratings and include:
leg labels each indicating leg procedural information about a corresponding leg on the charted aviation procedure; and
point labels each indicating point procedural information about a corresponding point on the charted aviation procedure; and
declutter the plurality of information labels for a zoomed out view and resolve resulting display conflicts between the plurality of information labels in favor of those with a relatively higher priority rating.

2. The system of claim 1, further comprising instructions to declutter the leg labels by moving each leg label along the corresponding leg between adjacent points to avoid collisions with at least the point labels.

3. The system of claim 1, further including instructions to display high priority point labels on the screen in a same geographic location in the zoomed out view and in a zoomed in view.

4. The system of claim 1, further including instructions to declutter the point labels by moving each point label in a respective direction away from the corresponding point for successively zoomed out views.

5. The system of claim 4, further including instructions to model the point labels as having charges that repel each other in order to move the point labels for the successively zoomed out views.

6. The system of claim 1, wherein the point labels comprise text boxes; and
wherein the instructions to resolve conflicts comprise instructions to display a foreground text box of a higher priority point label on the screen partially overlapping a background text box of a lower priority point label without obscuring text of either text box.

7. The system of claim 1, wherein the instructions to resolve conflicts comprise instructions to exclude an information label or a portion thereof.

8. The system of claim 7, further comprising instructions not to exclude high priority information labels or portions thereof.

9. The system of claim 1, wherein the instructions to resolve conflicts comprise instructions to scale the plurality of information labels in proportion to their priority rating.

10. The system of claim 1, further including instructions to receive an indication of the selected portion to be flown from a pilot.

11. The system of claim 1, further including instructions to receive an indication of the selected portion to be flown from an electronic device having a flight plan programmed therein.

12. The system of claim 1, wherein the charted aviation procedure comprises a departure;
wherein the selected portion to be flown includes legs and points corresponding to a takeoff runway and enroute transition, if any; and
wherein the system further includes instructions to:
display an initial leg of the departure on the screen at a zoomed in view; and
display a subsequent leg of the departure on the screen at the zoomed out view at least partially in response to completion of the initial leg.

13. The system of claim 1, wherein the charted aviation procedure comprises an arrival;
wherein the selected portion to be flown includes legs and points corresponding to an enroute transition and landing runway; and
wherein the system further includes instructions to:
display an initial leg of the arrival on the screen at the zoomed out view; and
display a subsequent leg of the arrival on the screen at a zoomed in view at least partially in response to completion of the initial leg.

14. The system of claim 1, wherein the charted aviation procedure comprises an approach;
wherein the selected portion to be flown includes legs and points corresponding to an initial approach fix, landing runway, and missed approach sequence; and
wherein the system further includes instructions to:
display an initial leg of the approach on the screen at the zoomed out view; and
display a subsequent leg of the approach on the screen at a zoomed in view at least partially in response to completion of the initial leg.

15. A system for decluttering an aviation navigation display, comprising:
a screen;
a processor coupled to the screen; and
a memory coupled to the processor and storing instructions executable by the processor to:
display on the screen, with a plurality of information labels, a selected portion to be flown of a charted aviation procedure and exclude an unselected portion not to be flown;
wherein the plurality of information labels have priority ratings and include:
leg labels each indicating leg procedural information about a corresponding leg on the charted aviation procedure; and
point labels each indicating point procedural information about a corresponding point on the charted aviation procedure;
declutter the plurality of information labels for a zoomed out view and resolve resulting display conflicts between information labels in favor of those with a relatively higher priority rating; and
declutter the leg labels by moving each leg label along the corresponding leg between adjacent points to avoid collisions with the point labels.

16. The system of claim 15, wherein each of the leg labels comprises a plurality of text strings placed in proximity to the corresponding leg; and
wherein the instructions to resolve conflicts comprise instructions to exclude at least one of the plurality of text strings for a leg label having a relatively lower priority rating than a conflicting information label.

17. The system of claim 16, wherein each of the plurality of text strings has a respective priority rating; and
wherein the instructions to exclude at least one of the plurality of text strings comprise instructions to exclude a text string having a lowest priority rating.

18. A system for decluttering an aviation navigation display, comprising:
a screen;
a processor coupled to the screen; and
a memory coupled to the processor and storing instructions executable by the processor to:
display on the screen, with a plurality of information labels, a selected portion to be flown of a charted aviation procedure and exclude an unselected portion not to be flown;
wherein the plurality of information labels have priority ratings and include:
leg labels each indicating leg procedural information about a corresponding leg on the charted aviation procedure; and
point labels each indicating point procedural information about a corresponding point on the charted aviation procedure;
display high priority point labels on the screen in a same geographic location in a zoomed out view and in a zoomed in view; and
declutter the plurality of information labels for the zoomed out view and resolve resulting display conflicts between information labels in favor of those with a relatively higher priority rating.

19. The system of claim 18, wherein the point labels comprise text boxes; and
wherein the system further comprises instructions to display those of the point labels having a high priority rating on the screen without scaling the text boxes for the zoomed out view.

20. The system of claim 18, further comprising instructions to declutter the leg labels by moving each leg label along the corresponding leg between adjacent points to avoid collisions with the point labels.
